(19) United States
(12) Patent Application Publication
(10) Pub. No.: US 2017/0018983 A1
(43) Pub. Date: Jan. 19, 2017

(54) ROTATABLE ELECTRICAL MACHINE

(71) Applicant: Valeo Equipements Electriques Moteur, Creteil Cedex (FR)

(72) Inventors: Nicolas LABBE, Lyon (FR); Raphaël ANDREUX, Lyon (FR)

(21) Appl. No.: 15/124,819

(22) PCT Filed: Feb. 26, 2015
(86) PCT No.: PCT/FR2015/050460

§ 371 Date: Sep. 9, 2016

(30) Foreign Application Priority Data
Mar. 12, 2014 (FR) 1452046

(51) Int. Cl. H02K 3/28; H02K 23/52; H02K 3/18; H02K 3/02; H02K 1/14; H02K 1/24

(52) U.S. Cl. CPC H02K 3/28; H02K 1/146; H02K 1/24; H02K 3/18; H02K 3/02; H02K 23/52; H02K 2213/03

(57) ABSTRACT

A rotatable electrical machine (1), particularly for a motor vehicle starter. The machine has an axis of rotation (X) and comprises a stator (2a) including: a generator field coil (4); including at least one wire (4a) comprising aluminum; and at least one pole shoe (3), including a winding core (31) whereon at least part of the stator winding is formed. The core has a center and a perimeter having at least one curved portion when observing the perimeter along an observational axis perpendicular to the rotational axis and through the center of the core.

The present invention relates in particular to a rotary electrical machine, which is or is not reversible, in particular a starter of a motor vehicle.)

Starters comprise an induced rotor and an inductor stator which are fitted coaxially. The rotor is integral with a drive shaft which rotates inside a head. The stator has a plurality of magnetic poles which are arranged on an inner circumferential surface of the head, and are constituted by poles around which inductor wires are wound, with the assembly constituting a wound inductor.

A wound inductor can be complex to produce, and require costly raw materials such as copper. Copper is used in wound inductors for its good electrical conductivity. The use of other less costly materials to replace the copper would be possible provided that the reduction in the electrical performance could be compensated for.

A starter is known from patent U.S. Pat. No. 3,877,142 comprising polar cores and a winding which is wound on these cores.)

The objective of the invention is to reduce the cost of electrical machines without detracting from the performance of these machines.

The objective of the invention is in particular a rotary electrical machine, in particular for a starter of a motor vehicle, this machine having an axis of rotation and comprising a stator comprising:
an inductor winding, which in particular is concentric, comprising at least one wire comprising aluminium;
at least one pole shoe comprising a winding core on which at least part of the stator winding is formed, the core having a centre and a periphery with at least one portion which is curved, when the periphery is observed according to an observation axis perpendicular to the axis of rotation and passing via the centre of the core.

By means of the invention, the wire comprising aluminium replaces the copper wire commonly used. The use of wire comprising aluminium instead of copper wire has the effect of reducing the costs of material. The decrease in the electrical resistance and the reduction of the length of the wire make it possible to obtain starting powers which are similar to those obtained using copper. The use of a pole shoe, the polar core of which has a modified geometry, has the effect of reducing the cross-section of this polar core. This makes it possible to reduce the length of the wire wound around the polar core in order to reduce the electrical resistance. In other words, the invention makes it possible to obtain a satisfactory compromise.

Preferably, the winding is a concentric winding.

Each winding core can be surrounded by a plurality of concentric turns.

According to an embodiment of the invention, the machine is designed to function with a supply voltage of 12 V and:
the winding is arranged in 2parallel tracks, and each winding core is surrounded by 4 turns of the winding; or
the winding is arranged in 4 parallel tracks, and each winding core is surrounded by 8 turns of the winding.

According to another embodiment of the invention, the machine is designed to function with a supply voltage of 24 V and:
the winding is arranged in 2 parallel tracks, and each winding core is surrounded by 8 turns of the winding; or
the winding is arranged in 4 parallel tracks, and each winding core is surrounded by 16 turns of the winding.

According to yet another embodiment of the invention, the machine is designed to function with a supply voltage of 48 V and:
the winding is arranged in 2 parallel tracks, and each winding core is surrounded by 16 turns of the winding; or
the winding is arranged in 4 parallel tracks, and each winding core is surrounded by 32 turns of the winding.

Each turn of the inductor winding can be formed by a single wire in hand or a plurality of wires in hand. In the case of one wire in hand, the turn is formed by winding a single wire around the winding core, this wire then preferably having along the turn a transverse cross-section with at least one flattened pan. In the case of a plurality of wires in band, the turn is formed by winding a plurality of wire simultaneously around the winding core.

Unexpectedly, the invention makes it possible to reduce the number of terms per pole shoe whilst complying simultaneously with the requirements of torque and electrical resistance.

Persons skilled in the art would have tended rather to retain a larger number of turns, for example a number of 5 turns per pole for a wiring diagram with two parallel tracks.

However, removing one turn for example makes it possible to ensure a correct level of torque which depends on the cross-section of wire and amps-turns, since, in the same space available, removing, one turn from out of 5 makes it possible to increase substantially the cross-section of the wire, to the extent of being able to change from copper to aluminium for the same useful power, because the resistance is the same.

In addition, persons skilled, in the art would retain 5 turns, and above all would not choose to reduce the number of turns to 4, because this would cause too many risks of centrifuging of the armature, with the high unloaded speed squared becoming too high with only 4 turns.

However, since the winding core with a form according to the invention has more flux, and therefore a satisfactory level of torque (for satisfactory resistance), even with only 4 turns, there is no risk of centrifuging of the armature.

Preferably, the machine comprises an armature, the length of the armature measured according to the axis of rotation being greater than, or equal to, the length of the pole shoe measured according to the axis of rotation. This makes it possible to exploit the surface area of the armature to the maximum from an electromagnetic point of view, without increasing the electrical resistance of the device.

Advantageously, the length of the pole shoe is greater than, or equal to, 90% of the length of the armature, in particular 95%, and preferably 97%.

If applicable, the length of the armature is between 30 and 40 mm, and in particular is substantially equal to 35 mm.

According to an embodiment of the machine, the length of the pole shoe is between 30 and 40 mm, and in particular is substantially equal to 34 mm.

Advantageously, when observed according, to the observation axis, the periphery of the polar core has an elongate form according to the axis of rotation.

Preferably, the periphery of the polar core has a form comprising two segments of straight line, which are preferably parallel, and are connected to one another by two portions of curve. This has the effect of establishing a compromise between the cross-section of the core and length of the wire of the inductor winding.

If applicable, at least one of the portions of curve corresponds to an arc of a circle.

According to an embodiment of the invention, the periphery of the polar core has an elliptical form when observed according to the observation axis, perpendicular to the axis of rotation. This geometry is an alternative to the periphery of the polar core with two segments of straight line, which are preferably parallel, and connected to one another by two portions of curve.

According to an embodiment of the invention, the periphery of the polar core has a circular form when observed according to the observation axis, perpendicular to the axis of rotation.

Preferably, the pole shoe comprises a widening which is connected to the core and is arranged radially on the interior relative to the core.

If applicable, the widening has a substantially rectangular form when observed according to the observation axis perpendicular to the axis of rotation.

Preferably, the widening has a span which is larger than that of the core when observed according to the observation axis perpendicular to the axis of rotation.

Advantageously, the length of the widening measured according to the axis of rotation is substantially equal to the length of the core.

Preferably, the widening has a circumferential dimension which is larger than that of the core.

If required, the machine can comprise a number of pairs of pole shoes equal to at least 2 or more.

According to an embodiment of the invention, the polar core is secured on a head of the stator by being screwed. This permits simple assembly and dismantling of the polar core.

Preferably, the pole shoe comprises a recess which passes through in the radial direction, this recess being used for screwing of the pole shoe onto a head. This permits the passage of a securing, element such as a tightening screw.

According to an embodiment of the invention, the polar core is secured on the head of the stator by being crimped.

Advantageously, the thickness of the polar core measured in the radial direction is between 5 and 8 mm, in particular between 6 and 7 mm, and preferably 6.5 mm.

If required, the machine can comprise winding wire which has on at least part of its length a transverse cross-section with at least one flattened part. This makes it possible to facilitate the filling of the winding wire around the polar core.

Preferably, the inductor winding comprises at least one turn of wire with a circular cross-section wound around a core of a pole shoe of the stator.

Advantageously, the wire comprises an aluminium core coated with copper. This makes it possible to improve the resistance to corrosion of the aluminium.

According to an embodiment of the invention, the machine forms a starter of a motor vehicle, the starter being simple to understand, either without the capacity to function as an alternator, or as a variant, being capable of functioning as an alternator.

The invention will be able to be better understood by reading the following detailed description of non-limiting embodiments of the invention and by examining the appended drawing in which:

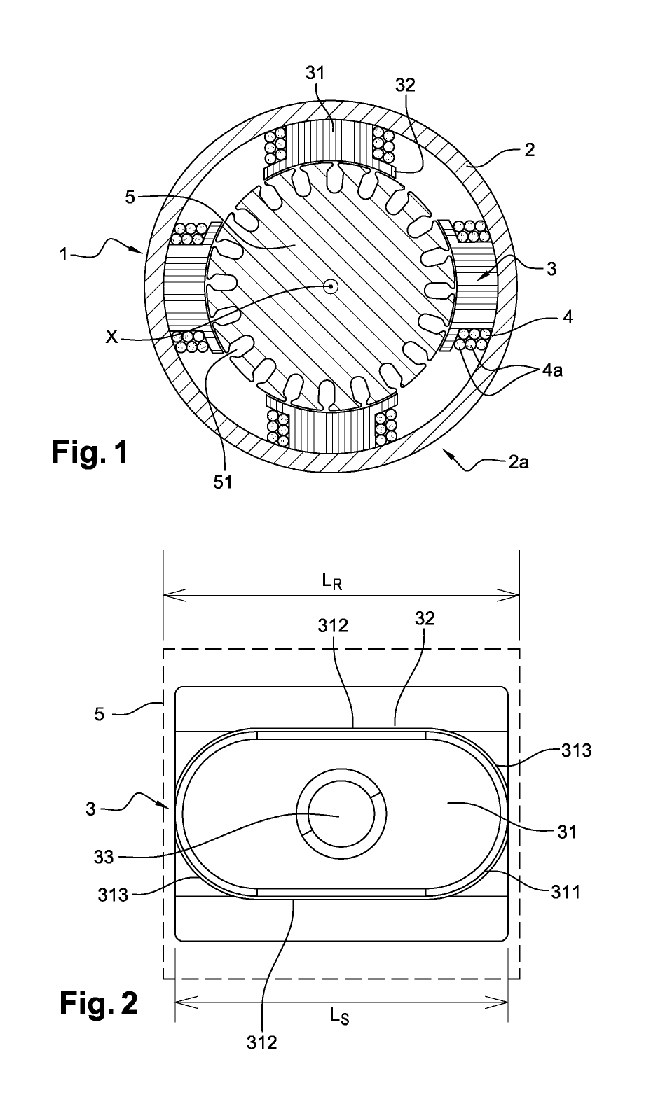

FIG. 1 represents schematically and partially a cross-section of the electrical machine according to the invention;

FIG. 2 represents a pole shoe of the machine in FIG. 1, which shoe is observed according to an observation axis perpendicular to the axis of rotation;

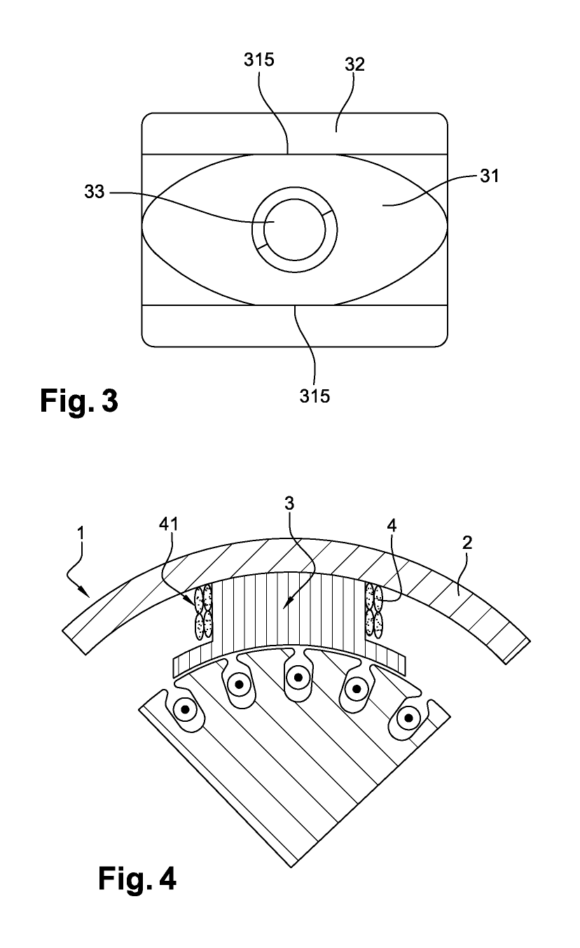

FIG. 3 represents a pole shoe according to another embodiment of the invention, observed according to the observation axis perpendicular to the axis of rotation, and

FIG. 4 illustrates schematically and partially a cross-section representing a portion of an electrical machine according to another embodiment of the invention.

FIG. 1 represents schematically a starter 1 for an internal combustion engine of a motor vehicle.

This direct current starter 1 comprises a stator 2a, or inductor, comprising a head 2 on which pole shoes 3 are secured, and a winding 4 formed by conductive wires 4a wound on these pole shoes 3. This starter 1 also comprises a rotor 5, also known as an armature, which can rotate around an axis of rotation X, inside the stator 2a. The rotor 5 comprises notches 51 which comprise wound armature wires which are not represented in FIG. 1. As can be seen in FIG. 2, the length Lr of the rotor 5 measured according to the axis of rotation X is greater than the length Ls of the pole shoe measured according to the axis X, such as to exploit the surface area of the armature to the maximum from an electromagnetic point of view, without increasing the electrical resistance of the device. In the example, the length of the pole shoe measured according to the axis X is more than 90% of the length of the armature. In the example, the length Lr of the rotor 5 is 35 mm and the length Ls is 34 mm.

As can be seen in FIG. 2, the pole shoe 3 comprises a core 31 and a widening 32.

The core 31 comprises a periphery 311 with a form which is elongate according to the axis of rotation X.

As illustrated in FIG. 2, the periphery 311 of the core 31 has a form comprising two parallel segments 312 which are connected to one another by two portions of curve 313, and at least one of the portions of curve corresponds substantially to an arc of a circle.

As illustrated in FIG. 3, as a variant, the periphery 311 of the core 31 has a globally elliptical form when observed according to the observation axis perpendicular to the axis of rotation X, with two parallel straight segments 315. In a variant not represented, the periphery 311 of the polar core 31 has a circular form when observed according to the observation axis perpendicular to the axis of rotation X.

The widening 32 is connected to the core 31 and is arranged radially on the interior relative to the core 31. The widening 32 has a substantially rectangular form when observed according to the observation axis perpendicular to the axis of rotation X, and has a span larger than that of the core 31 when observed according to the observation axis perpendicular to the axis of rotation X.

The widening 32 also has a circumferential dimension which is larger than that of the core 31.

As illustrated in FIG. 1, the machine comprises a number of pairs of pole shoes 3 equal to 2.

The core 31 is secured on the head 2 of the stator by being screwed. This permits simple assembly and dismantling of the core 31.

The pole shoe 3 comprises a recess 33 which passes through in the radial direction, this recess being used for the screwing of the pole shoe onto a head. This recess permits the passage of a securing screw for screwing onto the head 2 of the stator.

As a variant, the core 31 is secured on the head 2 of the stator by crimping.

The thickness of the core 31 measured in the radial direction is 6.5 mm.

As illustrated in FIG. 4, as a variant, the machine 1 comprises an inductor winding 4, the wire of which has on at least part of its length a transverse cross-section with at least one flattened part 41.

The winding is arranged in 2 parallel tracks and each winding core 34 is surrounded by 4 turns of the winding.

1. Rotary electrical machine (1), in particular for a starter of a motor vehicle, this machine, having an axis of rotation (X) and comprising a stator (2a) comprising:
an inductor winding (4), which in particular is concentric, comprising at least one wire (4a) comprising aluminium;
at least one pole shoe (3) comprising a winding core (31) on which at least part of the stator winding is formed, the core having a centre and a periphery with at least one portion which is curved (313), when the periphery is observed according to an observation axis perpendicular to the axis of rotation and passing via the centre of the core.

2. Rotary electrical machine according to claim 1, wherein the machine is designed to function with a supply voltage of 12 V and in that:
the winding is arranged in 2 parallel tracks, and each winding core is surrounded by 4 turns of the winding; or
the winding is arranged in 4 parallel tracks, and each winding core is surrounded by 8 turns of the winding.

3. Rotary electrical machine according to claim 1, wherein the machine is designed to function with a supply voltage of 24 V and in that:
the winding is arranged in 2 parallel tracks, and each winding core is surrounded by 4 turns of the winding; or
the winding is arranged in 4 parallel tracks, and each winding core is surrounded by 16 turns of the winding.

4. Rotary electrical machine according to claim 1, wherein the machine is designed to function with a supply voltage of 48 V and in that:
the winding is arranged in 2 parallel tracks, and each winding core is surrounded by 16 turns of the winding; or
the winding is arranged in 4 parallel tracks, and each winding core is surrounded by 32 turns of the winding.

5. Rotary electrical machine according to claim 1, wherein the machine comprises an armature, the length (Lr) of the armature measured according to the axis of rotation being greater than, or equal to, the length (Ls) of the pole shoe measured according to the axis of rotation.

6. Rotary electrical machine according to claim 5, wherein the length of the pole shoe is greater than, or equal to, 90% of the length of the armature, in particular 95%, and preferably 97%.

7. Rotary electrical machine according to claim 5, wherein the length of the armature is between 30 and 40 mm, and in particular is substantially equal to 35 mm.

8. Rotary electrical machine according to claim 5, wherein the length of the pole shoe is between 30 and 40 mm, and in particular is substantially equal to 34 mm.

9. Rotary electrical machine according to claim 1, wherein, when observed according to the observation axis, the periphery of the polar core has an elongate form according to the axis of rotation.

10. Rotary electrical machine according to claim 9, wherein the periphery of the polar core has a form comprising two segments of straight line (312), which are preferably parallel, and are connected to one another by two portions of curve (313).

11. Rotary electrical machine according to claim 10, wherein at least one of the portions of curve corresponds to an arc of a circle.

12. Rotary electrical machine according to claim 9, wherein the periphery (311) of the polar core has an elliptical form when observed according to the observation axis, perpendicular to the axis of rotation.

13. Rotary electrical machine according to claim 1, wherein the winding wire has on at least part of its length a transverse cross-section with at least one flattened part.

14. Rotary electrical machine according to claim 1, wherein at least one alloy element which constitutes the wire (4a) is copper.

15. Rotary electrical machine according to claim 1, forming a starter of a motor vehicle.

16. Rotary electrical machine according to claim 2, wherein the machine comprises an armature, the length (Lr) of the armature measured according to the axis of rotation being greater than, or equal to, the length (Ls) of the pole shoe measured according to the axis of rotation.

17. Rotary electrical machine according to claim 3, wherein the machine comprises an armature, the length (Lr) of the armature measured according to the axis of rotation being greater than, or equal to, the length (Ls) of the pole shoe measured according to the axis of rotation.

18. Rotary electrical machine according to claim 4, wherein the machine comprises an armature, the length (Lr) of the armature measured according to the axis of rotation being greater than, or equal to, the length (Ls) of the pole shoe measured according to the axis of rotation.

19. Rotary electrical machine according to claim 6, wherein the length of the armature is between 30 and 40 mm, and in particular is substantially equal to 35 mm.
